(19) United States
(12) Patent Application Publication
(10) Pub. No.: US 2012/0170471 A1
(43) Pub. Date: Jul. 5, 2012

(54) AUTOMATED ACCESS POINT SELECTION TO PROVIDE COMMUNICATION NETWORK PRESENCE TO A COMMUNICATION DEVICE

(75) Inventors: John R. Brown, Boynton Beach, FL (US); Eoin Hyden, Atherton (AU)

(73) Assignee: OPENPEAK INC., Boca Raton, FL (US)

(21) Appl. No.: 12/983,099

(22) Filed: Dec. 31, 2010

(51) Int. Cl. H04W 48/20

(52) U.S. Cl. 370/252

(57) ABSTRACT

A method of selecting an access point to provide communication network presence to a communication device. The method can include detecting a plurality of access points and performing scans of the detected access points over each of a plurality of period windows to detect short-term attributes and long-term attributes associated with each detected access point. When a new scan of the detected access points is performed over a new period window, an oldest set of short-term attributes can be purged from a prior period window. The short-term attributes, the long-term attributes and a time-invariant attribute can be processed for each of the access points to rank the access points in terms of priority. An access point having the highest priority can be selected to be the access point to provide the communication network presence to the communication device.

### BACKGROUND

1. Field of Technology

The present description generally relates to mobile communications and, more particularly, to access point selection.

2. Background

WiFi™ describes a range of technologies, including wireless local area network (WLAN) based on IEEE 802.11 standards, which support mobile communications. One notable feature of WiFi™ is the ability for a mobile communication device to maintain a persistent communication session while handing off from one access point to another. The determination of when to handoff usually is based on signal strength. When the signal strength of the presently used access point falls below a threshold value, the mobile communication device will begin evaluating the signal strength of other detected access points to choose a next access point to which to connect.

Oftentimes, there are a number of access points having suitable signal strength that are available to receive the handoff of the communication session. When this is the case, a determination must be made as to which access point will receive the handoff. Typically, the access point having the highest signal strength will be selected. If the signal strength provided by the available access points continually fluctuate, for instance due to movement of the communication device or adverse conditions in the communication environment, the communication device may continually hunt for other access points without settling with one access point for a reasonable period. This condition can unnecessarily tax processing resources both on the communication device and within the network infrastructure.

### SUMMARY

The present description relates to a method of selecting an access point to provide communication network presence to a communication device. The method can include via a processor, detecting a plurality of access points and performing scans of the detected access points over each of a plurality of period windows to detect short-term time-varying attributes (short-term attributes) and long-term time-varying attributes (long-term attributes) associated with each detected access point. When a new scan of the detected access points is performed over a new period window, via the processor, a set of short-term attributes can be purged from a prior period window. Via the processor, the short-term attributes, the long-term attributes and at least one time-invariant attribute can be processed for each of the access points to rank the access points in terms of priority. When a determination is made that it is appropriate to select at least one of the plurality of access points to provide the communication network presence to the communication device, the processor can select the access point having the highest priority to be the access point to provide the communication network presence to the communication device.

The method further can include, via the processor, assigning a performance value to each of the short-term attributes and the long-term attributes and assigning a weight to each of the short-term attributes and the long-term attributes. Processing the short-term attributes and the long-term attributes can include processing the performance values and the weights.

Assigning a performance value to a first of the short-term attributes can include evaluating a performance value associated with a second short-term attribute. The second short-term attribute can be associated with the first short-term attribute based upon a hierarchical relationship in which the second short-term attribute is subordinate to the first short-term attribute.

The determination that it is appropriate to select at least one of the plurality of access points to provide the communication network presence to the communication device can be made when a communication performance between the communication device and a presently connected access point traverses a threshold value.

At least one time-invariant attribute for each access point can include a network connection stability attribute that is assigned a performance value based on a stability of a communication session previously established between the communication device and the access point. The at least one time-invariant attribute for each access point also can include a cost of access attribute that is assigned a weight based on a cost associated with the communication device accessing the access point. The short-term attributes can include at least four attributes selected from a group consisting of signal strength, noise level, signal to noise ratio (SNR), latency, jitter, communication rate and communication quality.

Another arrangement relates to a communication device. The communication device can include a processor configured to detect a plurality of access points, and perform scans of the detected access points over each of a plurality of period windows to detect short-term attributes and long-term attributes associated with each detected access point. When a new scan of the detected access points is performed over a new period window, the processor can purge a set of short-term attributes from a prior period window. The processor can process the short-term attributes, the long-term attributes and at least one time-invariant attribute for each of the access points to rank the access points in terms of priority. When a determination is made that it is appropriate to select at least one of the plurality of access points to provide the communication network presence to the communication device, the processor can select the access point having the highest priority to be the access point to provide the communication network presence to the communication device.

The processor also can be configured to assign a performance value to each of the short-term attributes and the long-term attributes and assign a weight to each of the short-term attributes and the long-term attributes. Processing the short-term attributes and the long-term attributes can include processing the performance values and the weights.

Assigning a performance value to a first of the short-term attributes can include the processor evaluating a performance value associated with a second short-term attribute, wherein the second short-term attribute is associated with the first short-term attribute based upon a hierarchical relationship in which the second short-term attribute is subordinate to the first short-term attribute.

The processor also can determine that it is appropriate to select at least one of the plurality of access points to provide the communication network presence to the communication device when a communication performance between the communication device and a presently connected access point traverses a threshold value.

At least one time-invariant attribute for each access point can include a network connection stability attribute that is assigned a performance value based on a stability of a communication session previously established between the communication device and the access point. At least one time-invariant attribute for each access point also can include a cost of access attribute that is assigned a weight based on a cost associated with the communication device accessing the access point. The short-term attributes can include at least four attributes selected from a group consisting of signal strength, noise level, signal to noise ratio (SNR), latency, jitter, communication rate and communication quality.

Yet another embodiment can include a computer program product including a computer-readable storage medium having computer-usable program code that, when executed, causes a machine to perform the various steps and/or functions described herein.

### BRIEF DESCRIPTION OF THE DRAWINGS

Embodiments will be described below in more detail, with reference to the accompanying drawings, in which:

FIG. 1 depicts a communication system that is useful for understanding the present description;

FIG. 2 depicts a data table that is useful for understanding the present description;

FIG. 3 depicts an access point priority list that is useful for understanding the present description;

FIG. 4 depicts a block diagram of a communication device that is useful for understanding the present description;

FIG. 5 is a flowchart presenting a method of detecting access point attributes that is useful for understanding the present description; and

FIG. 6 is a flowchart presenting a method of selecting an access point to receive handoff of a communication session that is useful for understanding the present description.

### DETAILED DESCRIPTION

While the specification concludes with claims defining features that are regarded as novel, it is believed that the claims will be better understood from a consideration of the description in conjunction with the drawings. As required, detailed embodiments are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ virtually any appropriately detailed structure. Further, the terms and phrases used herein are not intended to be limiting but rather to provide an understandable description.

Arrangements described herein relate to access point selection in a wireless communication network while preferably maintaining a persistent connection. More particularly, when it is appropriate to select an access point to provide communication network presence to a communication device, various attributes of a plurality of detected access points can be monitored by the communication device to select an access point having a highest priority, and the access point having the highest priority can be selected to provide network presence to the communication device. The communication device then can establish an initial network connection to the communication network via the selected access point, or handoff to the selected access point from an access point to which the communication is presently connected while maintaining a persistent network presence.

The various attributes can be detected using repetitive sampling, and corresponding data can be maintained in a historical record. Some of the attribute data can be maintained temporarily over a short period, while other attribute data can be maintained over a long period. The attribute data can include attributes related to each access point's performance, attributes related to network service providers managing each of the access points, attributes related to financial costs associated with use of each access point, and other pertinent characteristics. The historical record corresponding to each detected access point can be evaluated to rank each access point in terms of priority.

Notably, the use of repetitive sampling, along with a history of established trust, to select the next access point minimizes the risk of adversely affecting performance of the present communication session due to the handoff, and ensuring that a persistent connection to the communication network is maintained.

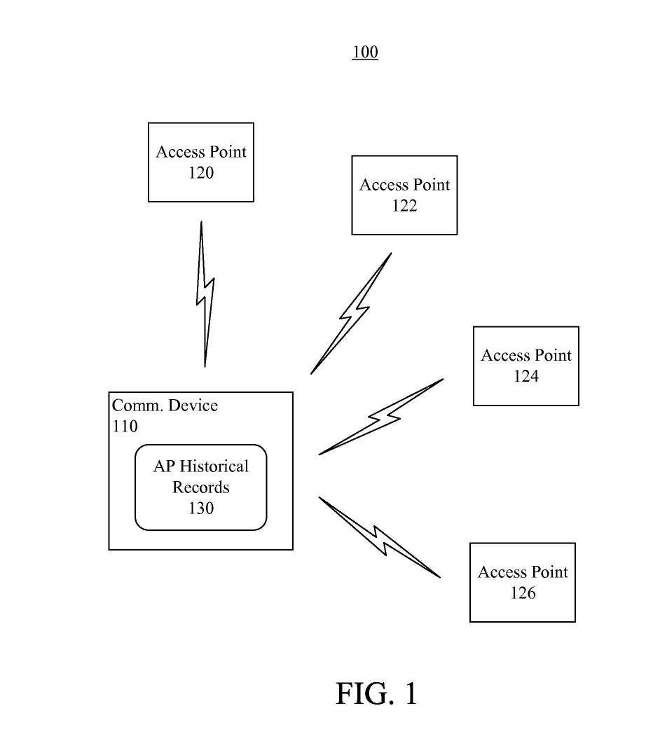

FIG. 1 depicts a communication system 100 that is useful for understanding the present description. The communication system 100 can include at least one communication device 110 and a plurality of access points 120, 122, 124, 126. The communication system 100 also can include any number of additional communication devices and access points (not shown), and the present arrangements are not limited in this regard.

The communication device 110 can be a mobile telephone (e.g., a smart phone), a mobile radio, a personal digital assistant, a computer, a mobile computer, a tablet computer, a mobile terminal, an application specific device, or any other mobile device that can transmit and/or receive wireless communication signals and establish network presence via an access point 120-126.

As used herein, the term “access point” means a device that wirelessly communicates with a communication device to provide to the communication device a connection to a communication network. The access points 120-126 can be, for example, base transceiver stations, repeaters, LAN access points, WLAN access points, or any other systems comprising equipment for wirelessly communicating with mobile communication systems, such as the communication device 110, to provide network presence of the communication device 110 on a communication network. As such, each access point 120-126 can comprise one or more antenna elements and one or more components for transmitting and receiving RF signals (e.g., transceivers). As known to those skilled in the art, the access points 120-126 also may include any of a myriad of other suitable components, for instance network adapters, communication ports, controllers, and so on, but the present arrangements are not limited in this regard. In one aspect, the access points 120-126 can be WiFi™ access points.

In operation, several attributes of each access point 120-126 can be detected and associated with the respective service set identifiers (SSIDs) of the access points 120-126. The SSIDs can be detected by the communication device 110 when the communication device 110 detects beacons and/or token whispers transmitted by the access points 120-126. The attributes can be detected by the communication device 110, or another device to which the communication device is communicatively linked, and can be processed to establish a level of trust, or priority, for each access point 120-126.

In one aspect, the attributes of each access point 120-126 can be detected by performing periodic scans of the access points 120-126. As used herein, the term “scan” means detect one or more signals generated by an access point and analyze information corresponding to the detection of the signals or information provided by the signals. In illustration, communications can be periodically established with each access point 120-126 over a period window. As used herein, a “period window” is a defined period over which measurements relating to an access point's attributes are taken. By way of example, each period window can be 100 ms, 300 ms, 500 ms, 1 s, 3 s or 5 s. Still, other period durations can be used and the present arrangements are not limited in this regard. Moreover, in one aspect, the period window can be a user selectable value, though this need not be the case. The number of period windows for which data is collected can be limited to a certain number of most recent period windows. Hereinafter, a period window may be referred to as “window.”

Attributes that are detected can include time-varying attributes and time-invariant attributes. Moreover, time-varying attributes can be categorized as short-term time-varying attributes and long-term time-varying attributes. As used herein, the term “short-term time-varying attribute” means an attribute that varies over a relatively short period, for example over a period between successive scans or a period in which a limited number of scans are performed (e.g., five scans, ten scans, etc.). In illustration, short-term time-varying attributes may over a period of milliseconds, seconds or minutes. As used herein, the term “long-term time-varying attribute” means an attribute that varies, but generally does not vary a significant amount over a relatively short period. For example, a long-term attribute may be relatively stable over a period of minutes, hours, days, weeks, months or years. In other words, the variations in a long-term time-varying attribute may not be detectable over a short period, or may not change within the short period. Hereinafter short-term time-varying attributes may be referred to as “short-term attributes,” and long-term time-varying attributes may be referred to as “long-term attributes.”

Short-term attributes for a window, such as an oldest window, can be purged when attributes are detected for a new window. Long-term attributes need not be purged when a new window occurs, and can be maintained indefinitely, or can be purged after a determined period. Such period can be minutes, hours, days, weeks, months, years, etc. Again, such period can be a user selectable value, though this need not be the case.

Examples of short-term attributes can include, but are not limited to, signal strength, noise level, signal to noise ratio (SNR), latency, jitter, and communication quality. The communication quality can be a quality, indicated by an access point in decibels (dBs), which potentially may impact throughput of communication signals between the communication device 110 and the respective access points 120-126, and stability of connection between the communication device 110 and the respective access points 120-126. If the communication rate (e.g., transmit rate and/or receive rate) varies over a short-term period, or varies over a number of windows for which attribute data varies among the windows, the communication rate also can be processed as a short-term time-varying attribute. Still, a myriad of other attributes that vary in the short-term can be detected and monitored, and such attributes also may be considered short-term attributes.

An example of a long-term attribute is connection stability. In illustration, if a certain access point provides intermittent connectivity or fluctuations in signal strength over periods greater than the short-term period, or any other undesirable long-term attributes, such attributes can be maintained in the historical record, and thus not purged when a new monitoring window occurs. Similarly, if a certain access point provides stable connectivity or stable signal strength, or any other desirable long-term attributes, such attributes also can be maintained.

As used herein, the term “time-invariant attribute” means an access point attribute that generally does not vary over time absent an intentional change in an access point setting, for example a change implemented by an entity managing the access point. Examples of time-invariant attributes include, but are not limited to, SSID, the communication service provider that manages the access point 120-126, the cost incurred to an account associated with the communication device 110 for establishing network presence on the access point 120-125, identifiers for services provided by the communication service provider, security settings and any other attributes that generally do not vary over time absent a change in service provider policy or fee structure.

Short-term and long-term time-varying attributes can be assigned performance values. In this regard, the time-varying attributes that relate to performance of communication links established with the access points can be referred to as “performance attributes.” The performance values can be actual measurements, scaled measurements, or values derived from processing actual measurements. For example, actual measurements can be processed using a heuristic algorithm to derive the performance values. Moreover, each of the time-varying attributes can be assigned a relative weighting based on the importance of the attribute with respect to desired communication goals. In this regard, weights for the various attributes can be dynamically assigned based on the performance values. The heuristic algorithm can, for example, apply fuzzy logic to determine the various weights.

Time-invariant attributes also can be assigned a performance value based on the performance and/or other impact of the attributes, and a relative weighting based on the importance of the attribute with respect to desired communication goals. For instance, if the communication device 110 previously established network presence via a particular access point 122, and that access point provided stable network connectivity, a connection stability attribute for the access point 122 can be assigned a particular performance value. If the communication device 110 previously connected to the access point 124, but the network connection was not very stable, the connection stability attribute for the access point 124 can be assigned a performance value that is lower than the connection stability performance value assigned to the access point 122. The weight assigned to the connection stability attribute can be based on a level of importance based on connection stability. Generally, the weight assigned to connection stability will be high in comparison to weights assigned to other attributes.

Some time-invariant attributes may not necessarily have an impact on performance, for example SSID, and such attributes need not be assigned a performance value, though they may be assigned a weight. In illustration, certain SSIDs may be preferred over other SSIDs, for instance based on the level of security or the network providers who manage the respective access points 120-126. Thus, for example, if the communication device 110 subscribes to a particular network provider, the SSIDs for access points 120-122 managed by that network provider can be assigned weights higher than access points 124-126 managed by other network providers.

Another example of a time-invariant attribute that may not impact access point performance is the cost for accessing an access point 120-126. Thus, the cost of access attribute for an access point 120-126 need not be assigned a performance value, but may be considered in the weighting assigned to the respective access points 120-126. For instance, if a particular access point 122 provides cost free connection to a communication network, the weighting assigned to the cost of access for that access point 122 can be a particular value. If connection to the access point 124 will incur fees to an account associated with the communication device 110, the cost of access assigned to the access point 124 can be weighted lower than the cost of access assigned to the access point 122. Moreover, the cost of access assigned to each access point 120-126 can be inversely scaled with respect to the cost of connection. In illustration, if the cost for accessing the access point 126 is lower than the cost of accessing the access point 124, the weighting applied to the cost of access for the access point 126 can be higher than the weighting applied to the access point 124.

In another aspect of the inventive arrangements, certain attributes can be associated with one another based on their hierarchical relationships. For instance, attributes can be categorized as high level attributes while other attributes can be categorized as subordinate attributes. In this regard, the performance values assigned to high level attributes can be based, at least in part, on the performance values assigned to their subordinate attributes. By way of example, signal strength can be a high level attribute while SNR can be a subordinate attribute that is associated with signal strength. If a particular access point 122 provides high signal strength, but a low SNR, while the access point 124 provides somewhat lower signal strength, but a high SNR, the performance value assigned to the signal strength of the access point 124 can be higher than a performance value assigned to the signal strength of the access point 122. Accordingly, the various attributes that are detected can be categorized in an attribute hierarchy that represents associations among the various attributes.

The attributes that are detected for each of the access points 120-126, the performance values, and the relative weights can be stored to a respective historical record 130 corresponding to each of the access points 120-126. The historical records 130 can be maintained in one or more data tables, hash tables, or in any other suitable structure(s) within the communication device 110, or within another device to which the communication device 110 is communicatively linked. The stored attributes can include both time-varying and time-invariant data corresponding to respective time-varying and time-invariant attributes.

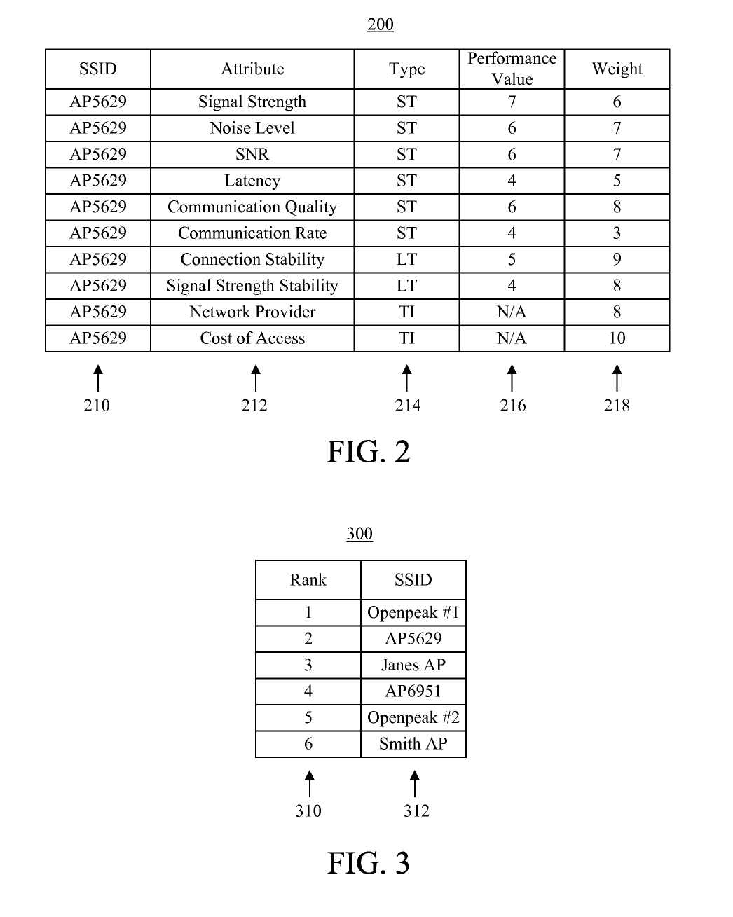

FIG. 2 depicts a data table 200, which is an example of a table that may be used to maintain the historical records. The table 200 can include a field 210 for SSID, a field 212 for attributes, a field 214 for identifying attribute types (e.g., short-term attributes, long-term attributes and time-invariant attributes), a field 216 for identifying performance values and a field for identifying assigned weights 218. Still, any number of other fields can be included in the table and the present arrangements are not limited in this regard. The example data table 200 includes attribute data for an access point having an SSID “AP5629.” Those skilled in the art will appreciate that the data table also can include attribute data for any number of access points, however, and each access point can have a unique SSID formatted in accordance with a suitable SSID format.

Referring again to FIG. 1, based on the performance value and relative weighting of each attribute, each access point 120-126 can be assigned an overall priority. For example, a heuristic algorithm that implements a decision tree can be applied to various attributes (including their performance values and/or assigned weights) to assign access point priority levels. In one arrangement, the algorithm can evaluate attribute trends, compare attributes to established threshold values, and perform other types of analysis on attribute data.

In illustration, if the signal strength of a particular access point 124 continually decreases over successive windows of measurement, this can indicate that the communication device 110 is moving away from the access point 124. Similarly, if the signal strength of a particular access point 126 continually increases over successive windows of measurement, this can indicate that the communication device 110 is moving toward the access point 126. Assuming that during the last window of measurement, the access points 124 and 126 provided similar signal strength readings, the performance value for the signal strength assigned to the access point 126 can be higher than the performance value for signal strength assigned to the access point 124.

Further, prioritization of access points 120-126 can sacrifice certain performance attributes to a degree in order to obtain other desirable performance attributes. For instance, the importance placed on transfer rate may be sacrificed to a small degree to give higher preference for obtaining an access point 120-126 that provides a high degree of connection reliability. In this regard, the weighting assigned to a reliability attribute can be higher than the weighting assigned to a transfer rate attribute.

The algorithm also can filter various attributes based on threshold values. For example, if the signal strength or signal to noise ratio provided by the access point 122 is below a threshold value, even though other parameters show good performance, the access point 122 can be assigned a low priority in comparison to other access points 120, 124-126, or removed from an access point priority list. In another example, if the SNR, jitter or latency provided by the access point 122, or cost associated with using the access point 122, is above a threshold value, even though other parameters show good performance, the access point 122 can be assigned a low priority in comparison to other access points 120, 124-126, or removed from an access point priority list.

An example of an access point list 300 is depicted in FIG. 3. The list can include a field 310 that identifies the priority ranking of each access point and a field 312 that identifies the SSID of each access point. The access points may be indicated in the list in the order corresponding to each access point's priority ranking, or in any other suitable order. For example, the access points can be indicated in the order in which the access points are detected, in which case the highest ranking access point need not be identified at a top of the access point list 300.

Referring again to FIG. 1, when it is appropriate for the communication device to establish initial presence on the communication network, or handoff from one access point to another, the access point 120-126 having the highest priority can be selected to provide network communication presence to the communication device 110. The determination as to when the handoff is appropriate can be based on one or more conditions. For example, the determination to initiate handoff can be made when one or more performance attributes of the current access point 120 meet or traverse a corresponding threshold values. Such attributes can be signal strength, transfer rate, latency, jitter or any other performance attributes that may affect a user's communication experience. In illustration, if the jitter or latency exceeds a threshold value, or the cost associated with using the access point 120 exceeds a threshold value, handoff of the communication device to another access point can be initiated. As another example, if the signal strength, SNR or transfer rate fall below a threshold value, handoff of the communication device to another access point can be initiated.

In this regard, if the access point 120 to which the communication device 110 is currently connected drops below the top ranking in the access point priority list, but the access point 120 still provides satisfactory communication performance, the communication device 110 can remain connected to that access point 120 until the communication performance between the communication device 110 and the access point 120 drops below a satisfactory level. Accordingly, the number of handoffs experienced by the communication device 110 can be minimized, thereby reducing the risk of interrupting a communication session currently established between the communication device 110 and the communication network due to access point handoff.

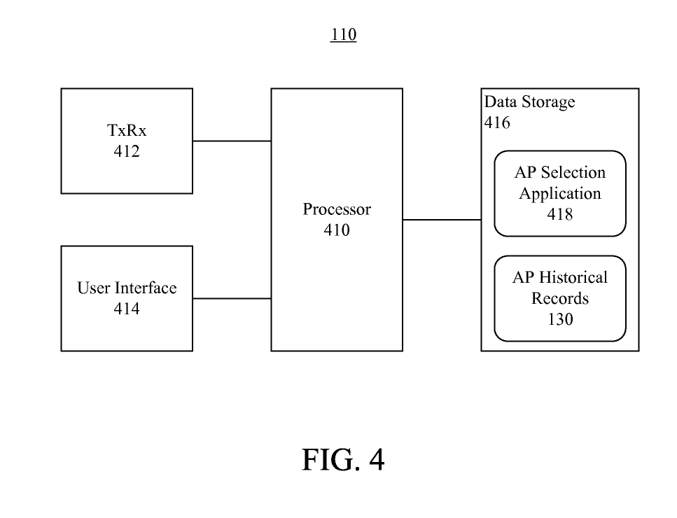

FIG. 4 depicts a block diagram of the communication device 110 that is useful for understanding the present description. The communication device 110 can include a processor 410, which may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The communication device also can include a transceiver 412 communicatively linked to the processor 410 via a suitable communication link, such as a communication bus. The transceiver 412 can modulate and demodulate signals to convert signals from one form to another, and can transmit and/or receive such signals over one or more various wireless communication networks. In illustration, the transceiver 412 can be configured to communicate data via IEEE 802 wireless communications, for example, 802.11 (e.g., WiFi™) and 802.16 (WiMAX), WPA, or WPA2. In another example, the transceiver 412 can communicate data via TDMA, CDMA, WCDMA, GSM, UMTS, GPRS, 3G, 4G, EUTRAN, UMB, OFDM, LTE, etc. Further, the transceiver 412 also can be configured to communicate over a wireless communication link using any of a myriad of communications protocols, for example, TCP/IP. In this regard, the transceiver 412 may be embodied as a wireless network adapter.

The communication device 110 further can include a user interface 414. The user interface 414 can comprise one or more tactile input devices, for example one or more buttons, keys, soft keys, sensors, or any other devices suitable for receiving a tactile user input. The user interface 414 also can include a display, input and output audio transducers, and the like. Such user interface components are well known to the skilled artisan and can be communicatively linked to the processor 410 via a suitable communication link and/or intervening components, examples of which include, but are not limited to, a graphics processing unit (GPU), and audio processing unit, a universal serial bus, etc.

The communication device 110 also can include a data storage 416 communicatively linked to the processor 410. The data storage 416 can include one or more machine-readable (e.g., computer-readable) storage devices, each of which may include, but is not limited to, a magnetic storage medium, an electronic storage medium, an optical storage medium, a magneto-optical storage medium, and/or any other storage medium suitable for storing digital information. In one arrangement, the data storage 416 can be integrated into the processor 410, though this need not be the case.

An access point selection application 418 can be stored on the data storage 416 or otherwise made accessible to the processor 410 The access point selection application 418 can be embodied as computer-usable program code and executed by the processor 410 to implement the methods and processes described herein that are performed by the communication device 110. For example, the processor 410 can execute the access point selection application 418 to detect access points, scan the detected access points to detect attributes associated with the access points, and assign performance values and weights to the detected attributes. The access point selection application 418 can implement one or more heuristic algorithms and fuzzy logic to assign the performance values and weights to the detected attributes. As noted, the attribute data can be stored in the access point historical records 130 and associated with the respective access points.

The access point selection application 418 also can be executed to rank the detected access points in terms of priority, determine when it is appropriate to handoff a current communication session from a present access point to another access point, select one of the detected access points to receive the handoff of the communication session based on which access point has the highest priority ranking, and initiate the handoff to the selected access point. The access point selection application 418 also can be executed to select an access point via which initial network presence is established.

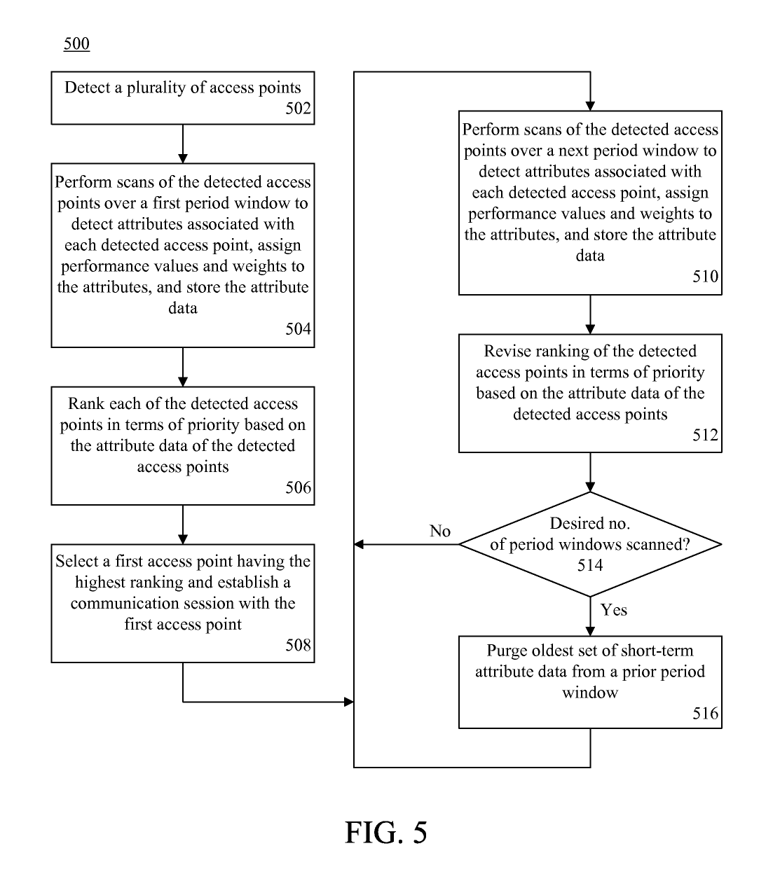

FIG. 5 is a flowchart presenting a method 500 of detecting access point attributes that is useful for understanding the present description. The method 500 depicted may be applicable to the embodiments described above in relation to FIGS. 1-4, but it is understood that the method 500 can be carried out with other suitable systems and arrangements. Moreover, the method 500 may include other steps that are not shown here, and in fact, the method 500 is not limited to including every step shown in FIG. 5. The steps that are illustrated here as part of the method 500 are not limited to this particular chronological order, either.

At step 502, the communication device can detect a plurality of other access points. For example, the communication device can detect beacons and/or token whispers from the other access points. At step 504, the communication device can perform scans of the detected access points over a first period window to detect attributes associated with each detected access point, assign performance values and weights to the attributes, and store the attribute data. As noted the attributes can include short-term attributes, long-term attributes, and time-invariant attributes. The attribute data can be stored in access point historical records, for instance in one or more data tables, in a data storage within the communication device or in a data storage otherwise communicatively linked to the communication device.

In one aspect, the performance values assigned to certain short-term attributes can be based, at least in part, on performance values assigned to other short-term attributes based on hierarchical relationships among the attributes. For example, when assigning a performance value to a first of the short-term attributes, the performance value assigned to a second short-term attribute can be evaluated when the second short-term attribute is subordinate to the first short-term attribute.

At step 506, the communication device can rank each of the detected access points in terms of priority based on the attribute data of the detected access points. For example, the long-term attributes and at least one time-invariant attribute for each of the access points can be processed to rank the access points in terms of priority. Such processing also can include processing one or more time-invariant attributes. Notably, the rankings of the detected access points can change due to changes in the assigned performance values and weights assigned to the attributes. Thus, the rankings may change after a new scan is performed, but this need not always be the case.

At step 508, the communication device can select a first access point having the highest ranking and establish communication session with the first access point.

At step 510, the communication device can perform scans of the detected access points over a next period window to detect attributes associated with each detected access point, assign performance values and weights to the attributes, and store the attribute data. The next period window need not immediately follow the first period window. For example, a delay can be implemented before the next set of scans is performed. Such delay can be a certain number of seconds or a certain number of minutes.

At step 512, the ranking of the detected access points can be revised in terms of priority based on the attribute data of the detected access points.

At decision box 514, a determination can be made as to whether a desired number of period windows have been scanned. If so, at step 516 a set of short-term attribute data from a prior period window can be purged. In illustration, if the desired number of period windows is five, the short-term attribute data for the oldest of the five windows can be purged. The process then can return to step 510 where scans for the detected access points are again performed over a next period window. Again, the next scan need not be immediately implemented, and can be delayed by a desired period.

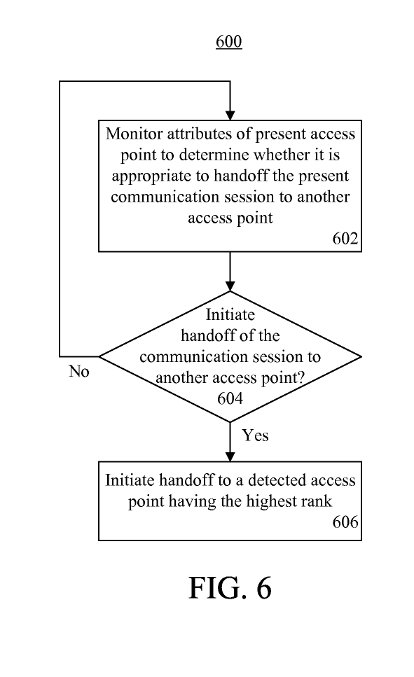

FIG. 6 is a flowchart presenting a method 600 of selecting an access point to receive handoff of a communication session that is useful for understanding the present description. The method 600 depicted may be applicable to the embodiments described above in relation to FIGS. 1-4, but it is understood that the method 600 can be carried out with other suitable systems and arrangements. Moreover, the method 600 may include other steps that are not shown here, and in fact, the method 600 is not limited to including every step shown in FIG. 6. The steps that are illustrated here as part of the method 600 are not limited to this particular chronological order, either.

The method 600 can be implemented anytime after step 512 of FIG. 5. In one arrangement, the method 600 can be implemented after scans have been performed over a desired minimum number of period windows, for example after step 516 of FIG. 5 has been performed at least once.

At step 602, attributes of the present access point can be monitored to determine whether it is appropriate to handoff the present communication session to another access point. At decision box 604, a determination can be made as to whether it is appropriate to initiate handoff of the communication to another access point. Such determination can be based on whether the performance of at least one of the monitored attributes falls below a threshold value. Such attributes can be signal strength, SNR, noise level, latency, jitter, communication rate, communication quality, communication stability, or any other attributes that are monitored.

If it is determined that handoff of the communication session is to be initiated, at step 606 handoff can be initiated to a detected access point having the highest rank as determined at step 510 of FIG. 5.

The flowcharts and block diagrams in the figures illustrate the architecture, functionality, and operation of possible implementations of systems, methods and computer program products according to various embodiments. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable or computer-readable program code that, when being loaded and executed, controls the processing system such that it carries out the methods described herein. The systems, components and/or processes also can be embedded in a computer-readable storage medium, such as a computer-readable storage medium of a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

The present arrangements can be embodied in other forms without departing from the spirit or essential attributes thereof. Accordingly, reference should be made to the following claims, rather than to the foregoing specification, as indicating the scope of the invention.

What is claimed is:

1. A method of selecting an access point to provide communication network presence to a communication device, comprising:
via a processor, detecting a plurality of access points;
via the processor, performing scans of the detected access points over each of a plurality of period windows to detect short-term time-varying attributes (short-term attributes) and long-term time-varying attributes (long-term attributes) associated with each detected access point;
when a new scan of the detected access points is performed over a new period window, via the processor, purging a set of short-term attributes from a prior period window;
via the processor, processing the short-term attributes, the long-term attributes and at least one time-invariant attribute for each of the access points to rank the access points in terms of priority; and
when a determination is made that it is appropriate to select at least one of the plurality of access points to provide the communication network presence to the communication device, via the processor, selecting the access point having the highest priority to be the access point to provide the communication network presence to the communication device.

2. The method of claim 1, further comprising:
via the processor, assigning a performance value to the short-term attributes and the long-term attributes; and
via the processor, assigning a weight to the short-term attributes and the long-term attributes;
wherein processing the short-term attributes and the long-term attributes comprises processing the performance values and the weights.

3. The method of claim 2, wherein assigning a performance value to a first of the short-term attributes comprises evaluating a performance value associated with a second short-term attribute, wherein the second short-term attribute is associated with the first short-term attribute based upon a hierarchical relationship in which the second short-term attribute is subordinate to the first short-term attribute.

4. The method of claim 1, wherein the determination is made that it is appropriate to select at least one of the plurality of access points to provide the communication network presence to the communication device when a communication performance between the communication device and a presently connected access point traverses a threshold value.

5. The method of claim 1, wherein the at least one time-invariant attribute for each access point comprises a network connection stability attribute that is assigned a performance value based on a stability of a communication session previously established between the communication device and the access point.

6. The method of claim 1, wherein the at least one time-invariant attribute for each access point comprises a cost of access attribute that is assigned a weight based on a cost or a security setting associated with the communication device accessing the access point.

7. The method of claim 1, wherein the short-term attributes include at least four attributes selected from a group consisting of signal strength, noise level, signal to noise ratio (SNR), latency, jitter, communication rate and communication quality.

8. A communication device, comprising:
a processor configured to:
detect a plurality of access points;
perform scans of the detected access points over one or more period windows to detect short-term time-varying attributes (short-term attributes) and long-term time-varying attributes (long-term attributes) associated with each detected access point;
when a new scan of the detected access points is performed over a new period window, purge a set of short-term attributes from a prior period window;
process the short-term attributes, the long-term attributes and at least one time-invariant attribute for each of the access points to rank the access points in terms of priority; and
when a determination is made that it is appropriate to select at least one of the plurality of access points to provide the communication network presence to the communication device, select the access point having the highest priority to be the access point to provide the communication network presence to the communication device.

9. The communication device of claim 8, wherein the processor is configured to:
assign a performance value to each of the short-term attributes and the long-term attributes; and
assign a weight to each of the short-term attributes and the long-term attributes;
wherein processing the short-term attributes and the long-term attributes comprises processing the performance values and the weights.

10. The communication device of claim 9, wherein assigning a performance value to a first of the short-term attributes comprises the processor evaluating a performance value associated with a second short-term attribute, wherein the second short-term attribute is associated with the first short-term attribute based upon a hierarchical relationship in which the second short-term attribute is subordinate to the first short-term attribute.

11. The communication device of claim 8, wherein the processor determines that it is appropriate to select at least one of the plurality of access points to provide the communication network presence to the communication device when a communication performance between the communication device and a presently connected access point traverses a threshold value.

12. The communication device of claim 8, wherein the at least one time-invariant attribute for each access point comprises a network connection stability attribute that is assigned a performance value based on a stability of a communication session previously established between the communication device and the access point.

13. The communication device of claim 8, wherein the at least one time-invariant attribute for each access point comprises a cost of access attribute that is assigned a weight based on a cost associated with the communication device accessing the access point.

14. The communication device of claim 8, wherein the short-term attributes include at least four attributes selected from a group consisting of signal strength, noise level, signal to noise ratio (SNR), latency, jitter, communication rate and communication quality.

15. A computer program product comprising:
a computer-readable storage medium comprising computer-usable program code stored thereon that selects an access point to provide communication network presence to a communication device, the computer-readable storage comprising:
computer-usable program code that detects a plurality of access points;
computer-usable program code that performs scans of the detected access points over one or more period windows to detect short-term time-varying attributes (short-term attributes) and long-term time-varying attributes (long-term attributes) associated with each detected access point;
computer-usable program code that, when a new scan of the detected access points is performed over a new period window, purges a set of short-term attributes from a prior period window;
computer-usable program code that processes the short-term attributes, the long-term attributes and at least one time-invariant attribute for each of the access points to rank the access points in terms of priority; and
computer-usable program code that, when a determination is made that it is appropriate to select at least one of the plurality of access points to provide the communication network presence to the communication device, selects the access point having the highest priority to be the access point to provide the communication network presence to the communication device.

16. The computer program product of claim 15, the computer-readable medium further comprising:
computer-usable program code that assigns a performance value to the short-term attributes and the long-term attributes; and
via the processor, assigning a weight to the short-term attributes and the long-term attributes;
wherein processing the short-term attributes and the long-term attributes comprises processing the performance values and the weights.

17. The computer program product of claim 16, wherein the computer-usable program code that assigns a performance value to a first of the short-term attributes comprises computer-usable program code that evaluates a performance value associated with a second short-term attribute, wherein the second short-term attribute is associated with the first short-term attribute based upon a hierarchical relationship in which the second short-term attribute is subordinate to the first short-term attribute.

18. The computer program product of claim 15, wherein the computer-usable program code determines that it is appropriate to select at least one of the plurality of access points to provide the communication network presence to the communication device when a communication performance between the communication device and a presently connected access point traverses a threshold value.

19. The computer program product of claim 15, wherein the at least one time-invariant attribute for each access point comprises a network connection stability attribute that is assigned a performance value based on a stability of a communication session previously established between the communication device and the access point.

20. The computer program product of claim 15, wherein the at least one time-invariant attribute for each access point comprises a cost of access attribute that is assigned a weight based on a cost associated with the communication device accessing the access point.

21. The computer program product of claim 15, wherein the short-term attributes include at least four attributes selected from a group consisting of signal strength, noise level, signal to noise ratio (SNR), latency, jitter, communication rate and communication quality.
